(19) United States
(12) Patent Application Publication
(10) Pub. No.: US 2011/0031084 A1
(43) Pub. Date: Feb. 10, 2011

(54) DELAYED LOCK UP/FREEWHEEL BEARING AND AN IMPROVED NON-BONDED TORSION BUSH

(76) Inventor: Malcolm Tomlinson, Luton (GB)

Correspondence Address: DOBRUSIN & THENNISCH PC, 29 W LAWRENCE ST, SUITE 210, PONTIAC, MI, 48342, US

(21) Appl. No.: 12/865,249

(22) PCT Filed: Jan. 14, 2009
(86) PCT No.: PCT/EP09/00172

§ 371 Date: Oct. 25, 2010

(30) Foreign Application Priority Data
Jan. 14, 2008 (GB) 0800545.6
Jan. 14, 2008 (GB) 0800546.4

(51) Int. Cl. F16D 41/064; F16D 41/06

(52) U.S. Cl. 192/45; 192/41 R

(57) ABSTRACT

A bearing which introduces a delay into the lock up path of a reverse activated activator, typically the delay is half a revolution, such that any unintentional minor reversal from the freewheel direction can be tolerated without triggering an unwanted response, the bearing is particularly useful to delay the action of a reverse stimulated rotational activity such as the activation of a brake or a bicycle stabilizer. Improved bearings and bushes useful in this application are also provided.

In a first embodiment the present invention relates to bearings that freewheel in one direction and lock up when the direction is reversed from the direction of freewheel. These bearings are particularly useful in retarding the motion of wheel based activities such as cycles including bicycles and tricycles or in activating auxiliary features such as stabilisers.

These assemblies are typically constructed with a ball race bearing in parallel with a ramp and roller type lock up clutch on shared inner and outer rings. These bearings normally lock up immediately the direction of rotation reverses from the freewheeling mode. However, this invention relates to a modification whereby the lock up and/or the unlocking can be delayed by a desired fraction of a rotation such as up to a half turn. This has been found to be highly desirable feature for the deployment unit of a bicycle stabilizer such as that described in GB 2406082 A. the invention differs from GB 2406082A in providing a different lock up bearing principle and separates the lock up system to enable a delay to be built into the lock up activation.

The invention is particularly useful in that it can prevent or reduce the likelihood of accidental activation of a reverse direction activity such as the activation of a brake or the deployment of a stabiliser system such as is described in GB 2406082 A. Specifically when used with cycle stabilisers, it allows the cyclist to reverse the pedals for half a turn before rotating the crank sited deployment unit cam, thereby deploying or retracting the stabilizer. This prevents accidental deployment when, for example, reverse pedalling to set the pedals horizontally when the cyclist is freewheeling downhill; and unintentional retraction (unlocking) when pumping pedals (forwards and backwards) during very low speed operation when the stabilizer is deployed. It also facilitates automatic stowage of the stabilizer (by virtue of a rat trap return spring) with minimal reverse pedalling beyond release from the deployed detent.

The present invention therefore provides a bearing with a directional freewheeling lock up facility wherein means are provided whereby the locking and/or unlocking action is delayed. In a particular embodiment the locking and/or unlocking action is activated by the reverse pedalling of a bicycle.

The delayed lock up is achieved by adding a further ring into the lock up path to provide 3 chambers, each of which confines a ball bearing which abuts the chamber ends at the delay extremes.

The bearing can be designed so that the timing of the delay can be any fraction of a reverse revolution according to the requirements of the vehicle with which the bearing is used. We have found that for activation of a stabilizer system according to GB 2406082 A, a delay of approximately half a revolution is particularly useful.

The invention will now be described solely by way of example with reference to the accompanying drawings in which:

FIG. 1 shows the standard clutch freewheel.

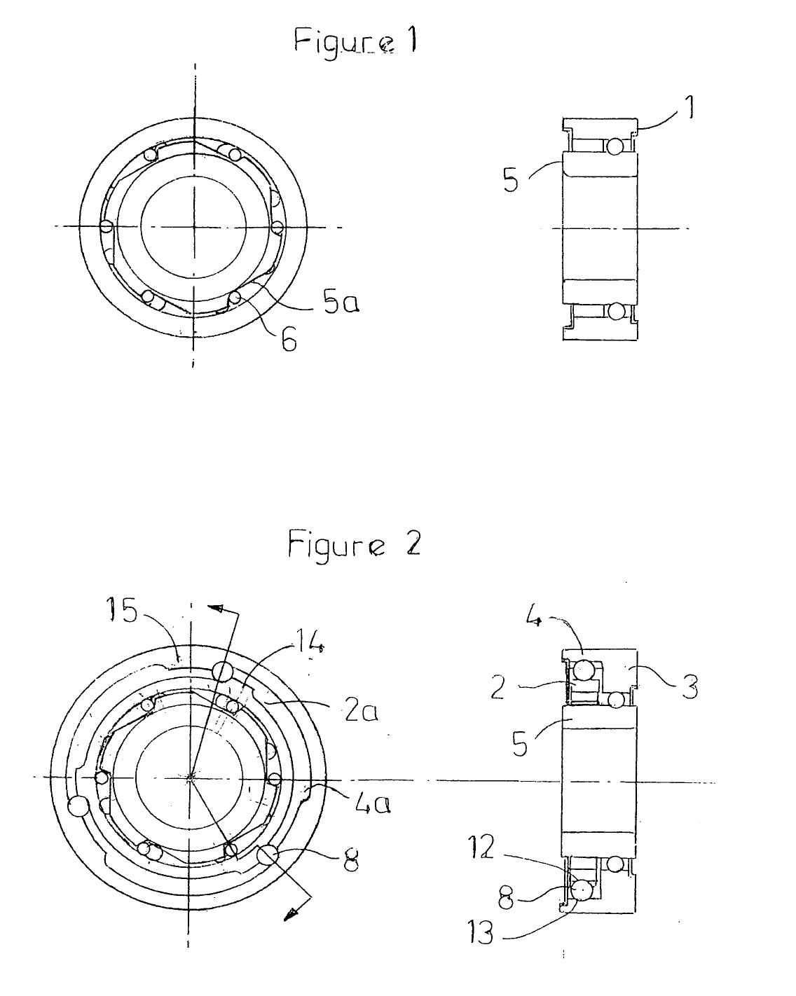

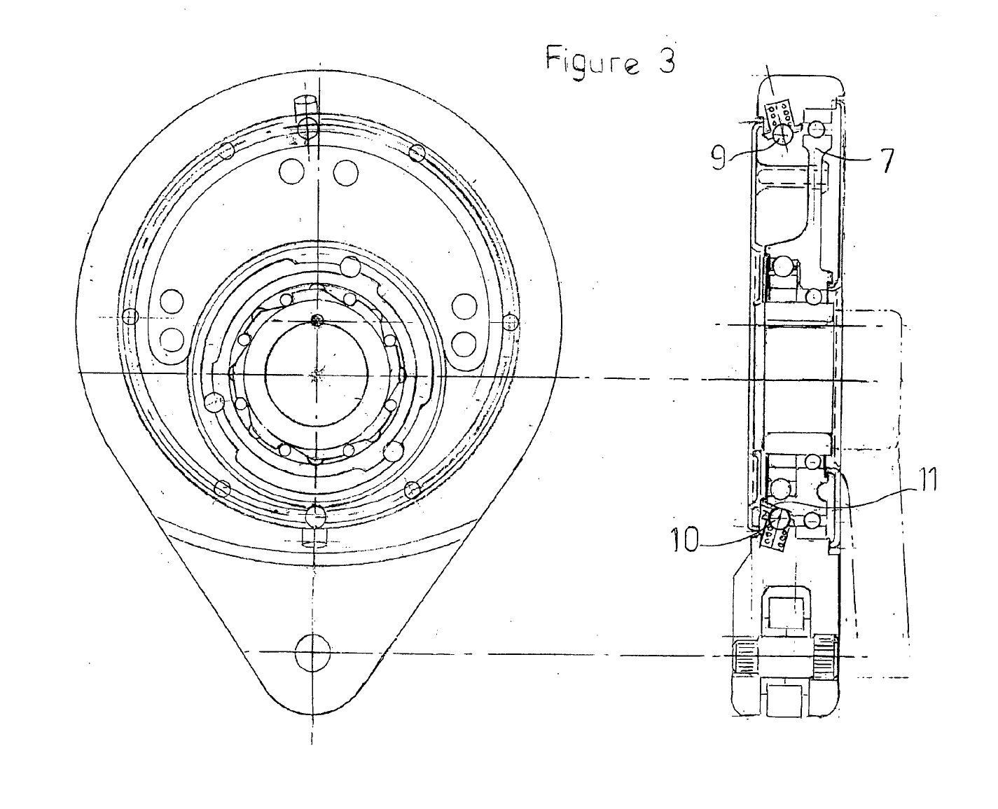

FIG. 2 shows the introduction of the delay feature.

FIG. 3 shows the invention incorporated into a bicycle stabilizer deployment unit.

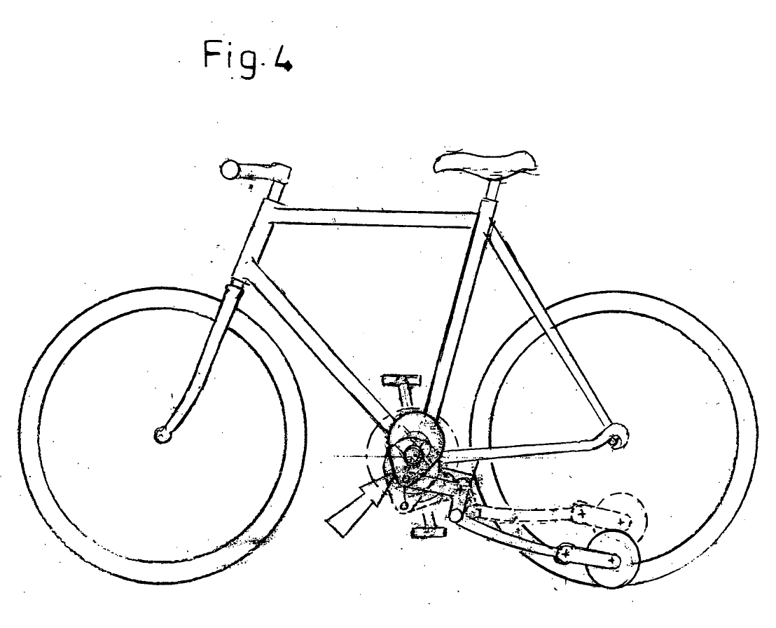

FIG. 4 shows a schematic highlighting the stabilizer deployment unit.

In FIG. 1, anticlockwise (ACW) rotation of the inner ring (5), relative to the outer ring (1), allows freewheeling. Clockwise (CW) rotation allows small springs to wedge the rollers (6), between the ramps (5a), and outer ring (1), thereby producing lock up.

FIG. 2, and FIG. 3 show the invention in that:

The outer ring 1, has been separated into the clutch portion (2) and the ballrace portion (3). An additional ring (4), has been added outboard of the clutch outer ring (2). This additional ring (4), is rigidly fixed to, or part of, the roller bearing outer ring (3). For compactness, the large diameter cam bearing inner race (7), might also be part of this arrangement.

The separated clutch outer ring (2), and the added outboard ring (4), each have 3 equally spaced but opposed cut aways (2a), and (4a), such that when assembled, 3 circumferential chambers are formed each of which contains a tracked ball bearing 8, thereby giving axial location to the clutch outer ring (2), to prevent axial float and contact with adjacent elements which might inhibit priming the delay, e.g. as might occur with (non tracked) rollers.

In operation forward pedalling will rotate the inner ring of the clutch (5), ACW, which wants to overrun its outer ring (2), but the drag of the baulked clutch rollers (6), is imparted to the clutch outer ring (2), and first primes the delay by rolling each of the three chamber ball bearings 8, until they abut opposing ends of the inner and outer cut aways, (2a) and (4a), (as shown) at which point the clutch overruns as without the modifications.

Reverse pedalling rotates the inner ring CW and immediately locks up the clutch but it takes (say) half a revolution to roll the three chamber ball bearings (8), to abut the opposite extremes of the cut aways (2a), (4a), which then locks the whole bearing assembly and rotates the cam (7), to deploy or retract the stabilizer and engage detents (10), (9), in the groove (11), at top and bottom dead centre (TDC and BDC) to hold these positions.

By using tracked ball bearings (8), it not only provides axial location to the clutch outer ring (2), but operates similar to an epicyclic gear whereby the aggregate delay, e.g. half a turn, is the sum of the subtended angles of each outer and each inner cut outs (4a), (2a), after taking account of the ball bearing contact diameters. It also gives minimal resistance to rotation and thus primes the delay before the clutch overruns.

To facilitate manufacture, the tracks (12), (13), may be continuous through the baulks (14), (15); only the ball (8), contacts with the remaining walls providing the baulking force. The 3 locking balls should provide sufficient lock up torque without brinelling since there is virtually no impact loading in this application; only progressive deployment loading and detent loads. Even so, any brinelling would not inhibit the function of the device and would be self limiting. This application might also permit reducing the number of lock up rollers and ramps (to say 3) to reduce overrun drag to an absolute minimum and may also facilitate assembly of the three chamber ball bearings 8.

This invention further provides a non bonded, self assembly, repeatably adjustable torsion bush. One use of such a bush is in a bicycle stabilizer system that can be used as the suspension element in a deployable stabilizer for bicycles as proposed in GB 2406082A. A preferred stabilizer system accordingly employs a lock up bearing according to one embodiment of the invention together with a torsion bush according to this further embodiment of the invention.

A conventional elastomeric bush has a metallic outer casing and central tube separated by an elastomer which is chemically bonded to both the outer casing and the central tube. When used as a torsion spring, one element (say the outer casing) is rigidly fixed or anchored, and the other element (central tube) is rigidly attached to (typically) an arm which applies the torsional loading.

The moulding/bonding/curing process to produce such a conventional bush is costly as the metallic elements must have a bonding agent applied prior to loading into a mould into which the elastomer is introduced. Further, to anchor the bush and transmit torque to the torsion arm requires specific design; and adjustment is often via matching a serrated tube end or by physically keying the tube ends, via e.g. by clamping star washers between the tube end and a lever/arm.

The serrated end method means that adjustment is coarsely incremental and may require further fine adjustment or precise anchoring of the outer casing. The star washer method does not lend itself to repeated adjustment as the tube ends will suffer damage and, subsequently, not accept even pristine star washers. Although successfully used for heavy duty and continuously loaded applications this type of mounting does not lend itself to lighter periodically loaded applications with which this invention is particularly concerned.

The bush of the present invention can be basically described as similar to a pair of taper roller bearings with the minor PCD's (pitch circle diameters) abutting each other, but with the potential to provide location, transmit torque, and deflect under torque. Specifically, it consists of an outer ring which is formed into 2 opposed sets of (for example) equispaced concave, tapered recesses; and 2 inner mouldings each with recesses that oppose those in the outer ring. The inboard contacting faces of these mouldings key into each other when assembled such that both transmit any applied torque. The springing of the bush is achieved by introducing frustrum shaped plugs into each of the voids formed as the mouldings are axially introduced at opposite ends of the outer ring, typically 6 voids are formed; the plugs are preferably of elastomeric material. Profiling the recesses and varying the rubber hardness will enable the torsion characteristics to be tailored. The elastomer frustrum may have judicious rounding on the base to improve contact with the compressing flange on the moulding and thereby resist axial distortion.

The fine, and repeatable adjustment may be achieved by interposing a hexagonal washer between the torque arm and an inner moulding outboard face. This washer has a number of protrusions (pips) on PCDs which may differ in diameter on each face. These pips are designed to locate in a matching sets of indentations on an inner moulding and on the torque arm. The total number of pips on each face must differ by one from the opposite face to facilitate a differential increment. e.g. 9 and 10 such that by loosening the clamping load the hexagonal washer can be rotated to its adjacent position on the moulding i.e. 1/9 of a turn or 40 degrees and the torque arm can be rotated in the opposite direction i.e. 1/10 of a turn or 36 degrees. The relative angular movement is therefore 40−36=4 degrees. The clamping load may then be reapplied.

This aspect of the invention will now be described solely by way of example with reference to the accompanying drawings in which:

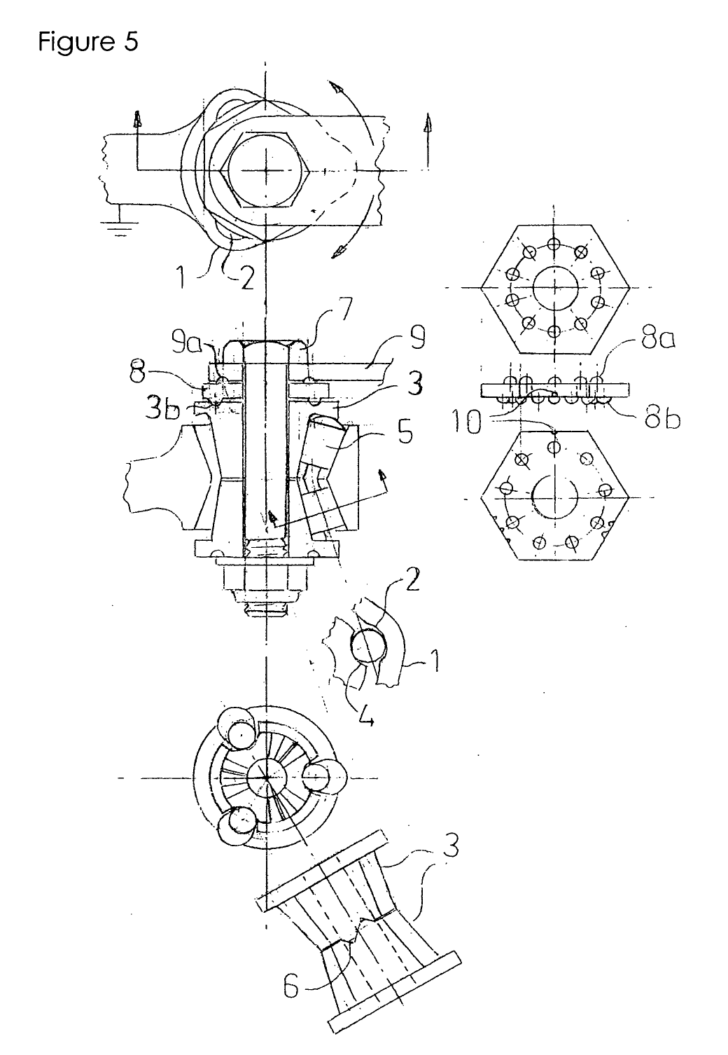

FIG. 5 shows a bush and its assembly.

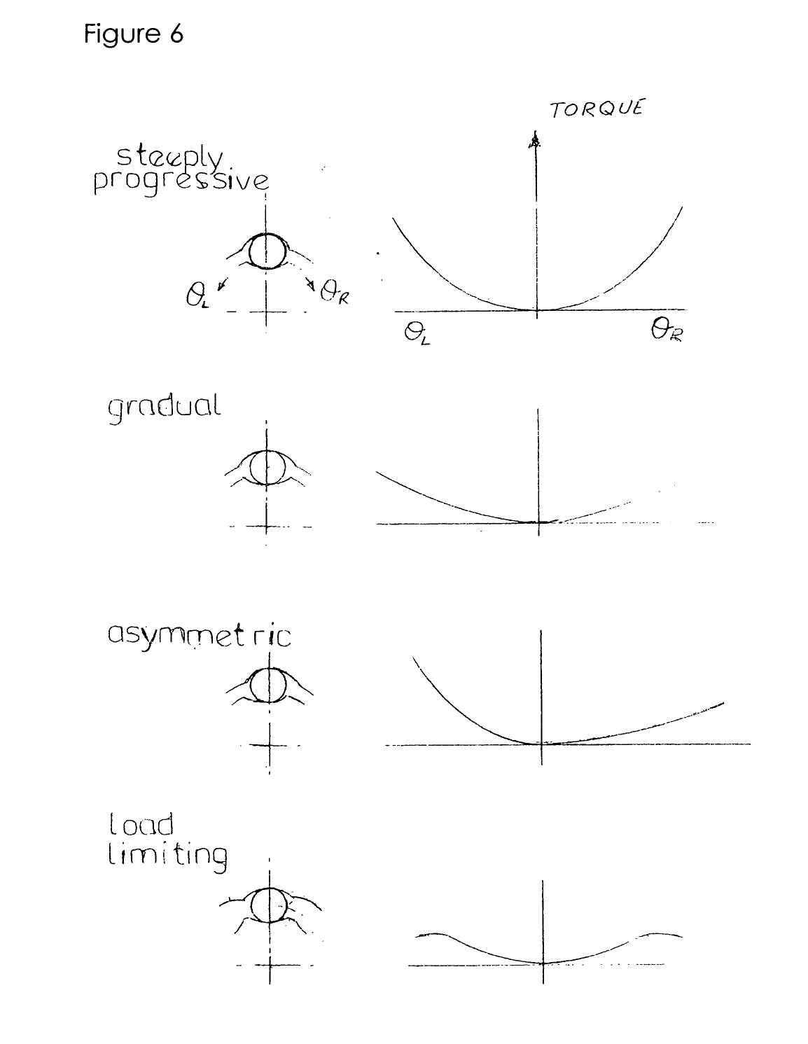

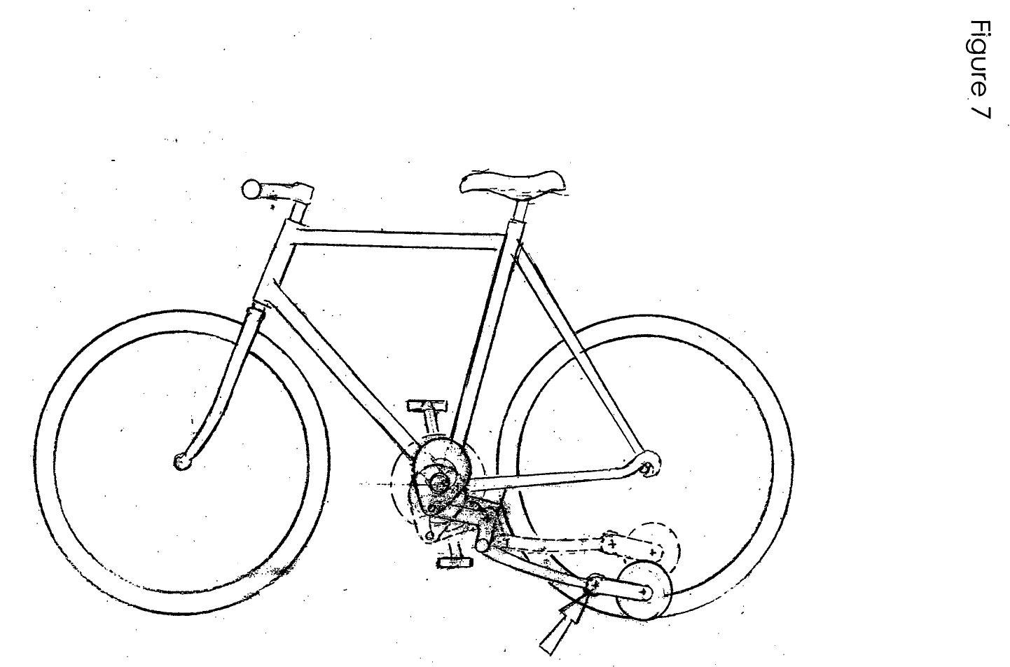

FIG. 6 shows recess profiles in the bush and their effect on torsion characteristics.

FIG. 7 shows a schematic of a bicycle and highlights the application of a bush of the invention in a bicycle stabilizer system.

In FIG. 5, the outer containment ring (1), comprises two sets of three symmetrically opposed recesses (2). Each of the two inner mouldings (3), has three corresponding recesses (4), which are aligned with recesses (2), when the elastomer frustrum plugs (5), are introduced. Each inner moulding (3), is also aligned with, and effectively joined to the other by three sets of serrations (6), when the clamping bolt (7), is tightened. An angular adjustment washer (8), is introduced between the torque arm (9), and the inner moulding (3), such that the arm (9), is set relative to the base containment ring (1), by engaging the moulding indentations (3b), with the appropriate washer pips (8b), and locating the washer pips (8a), into the torque arm indentations (9a), then tightening the clamping bolt (7), having first introduced the frustrum plugs (5).

To facilitate sub assembly prior to final installation, the number of pips (8b), locating in the moulding indentations (3b), is preferably a multiple of, and symmetrical about, the number of recesses (4), whence orientation of the adjustment washer (8), relative to the base containment ring (1), can be predetermined by moulding a series of identifying marks 10, to the middle edge of (say) 3 non adjacent hexagonal faces e.g. I, II, III. Then, by presenting a selected one of these marks (10), close to, or a judgeable distance away from a known or marked position on the containment ring (1), the washer pips (8b) will then settle into their closest moulding indentations (3b), whence the adjustment washer (8), will be correctly set relative to the containment ring (1). Similarly, the torque arm (9), can then be approximated to it's desired position and presented to the washer (8), whence the torque arm indentations (9a), will also settle onto the washer pips (8a), in the desired position, before tightening the clamping bolt (7).

This is practicable since the operator need only judge positions to +/−40 degrees and +/−36 degrees respectively.

What is claimed is:

1. A bearing comprising: a directional freewheeling/lockup facility whereby locking is delayed by a fraction of a revolution.

2. A bearing according to claim 1, wherein the delay is half a revolution.

3. A bearing as in claim 1, wherein the delayed lockup is achieved by circumferentially separating the outer ring and interposing an additional outboard element into the lockup path with said element being reconnected to the bearing output ring.

4. A bearing as in claim 1, wherein a multiplicity of chambers are formed by the lockup outer ring and the added element, in combination with a trapped and tracked ball bearing in each chamber, provides the delay feature by travelling between extremities of the formed chamber to about the opposite extremities.

5. A bearing as in claim 1, wherein the delay operates in both the lock up and the freewheel directions.

6. A bearing as in claim 4, wherein the trapped ball race tracks may be continuous with the tracked ball abutment occurring at the inner edges of the parted baulk walls.

7. (canceled)

8. An elastomeric torsion bush wherein the torsion resistance is achieved by compressing a number of frustrum shaped elastomeric elements.

9. A bush as in claim 8, wherein the elastomeric elements are inclined similar to the rollers in a pair of opposed taper roller bearings but with the elements constrained in chambers such that rotation of the inner with respect to the outer is opposed through compressing the elastomer.

10. A bush as in claim 8, wherein the outer ring and inner mouldings have recesses which, when assembled, oppose each other and compress and constrain elastomeric frustra.

11. A bush as in claim 8, wherein the inner mouldings key into each other when abutted thereby providing alignment and sharing torsion loads.

12. A bush as in claim 8, wherein torque arm positions can be positively and repeatedly adjusted by means of a washer with a multiplicity of equispaced pips on either side, the numbers on each side differing by one such that engagement with corresponding indentations in their mating parts can produce a differential increment.

13. A bush as in claim 8, wherein the profile of the chambers affects the torsion characteristics.

14. A bush assembly as in claim 9, wherein the inner moulding flanges are extended and flanged over such that when assembled the flanges will project outward from the circular perimeter of the outer moulding thereby providing a dust shield.

15. A bush assembly as in claim 9 wherein, the angle of the frustra axis is increased whereby a constrained yet universal isolation mounting is created.

16. (canceled)

17. A method of using a bearing comprising:
delaying locking by a fraction of a revolution, wherein the bearing has a directional freewheeling/lockup facility.

18. A bearing as in claim 2, wherein the delayed lockup is achieved by circumferentially separating the outer ring and interposing an additional outboard element into the lockup path with said element being reconnected to the bearing output ring.

19. A bearing as in claim 18, wherein a multiplicity of chambers are formed by the lockup outer ring and the added element, in combination with a trapped and tracked ball bearing in each chamber, provides the delay feature by travelling between extremities of the formed chamber to about the opposite extremities.

20. A bush as in claim 9, wherein the outer ring and inner mouldings have recesses which, when assembled, oppose each other and compress and constrain elastomeric frustra.

21. A bush as in claim 20, wherein the profile of the chambers affects the torsion characteristics.

22. A bush as in claim 21, wherein the inner moulding flanges are extended and flanged over such that when assembled the flanges will project outward from the circular perimeter of the outer moulding thereby providing a dust shield.
